(19) United States
(12) Patent Application Publication
(10) Pub. No.: US 2012/0154860 A1
(43) Pub. Date: Jun. 21, 2012

(54) INFORMATION PROCESSING APPARATUS, PRINTING CONTROL METHOD, AND STORAGE MEDIUM

(75) Inventor: Yosuke Ito, Kawasaki-shi (JP)

(73) Assignee: CANON KABUSHIKI KAISHA, Tokyo (JP)

(21) Appl. No.: 13/316,880

(22) Filed: Dec. 12, 2011

(30) Foreign Application Priority Data
Dec. 15, 2010 (JP) 2010-279396

(51) Int. Cl. G06F 3/12; G06K 15/02

(52) U.S. Cl. 358/1.15; 358/1.16

(57) ABSTRACT

An information processing apparatus reads setting information indicating a print setting corresponding to a user operation and content information of a print target from a storage device, and generates job information to be used in printing in an image forming apparatus by combining the setting information and information indicating that the content information is referred to.

### BACKGROUND OF THE INVENTION

1. Field of the Invention

The present invention relates to an information processing apparatus, a printing control method, and a storage medium.

2. Description of the Related Art

Recently, along with the increasing speed and higher image quality of electrophotographic printing apparatuses and inkjet printing apparatuses, the “print-on-demand” market has been spreading. On the other hand, conventionally, there have been workflow systems which file and manage printing target content data as well as print setting information to be applied on this content data. Filed print setting information is commonly referred to as a “job ticket” or a “print ticket”.

As this conventional technology, Japanese Patent Application Laid-Open Nos. 2007-249857 and 2008-33812 discuss techniques in which an XML paper specification (XPS) print ticket is utilized. Further, Japanese Patent Application Laid-Open No. 2009-271930 discusses a technique in which a job definition format (JDF) job ticket is utilized.

For example, Japanese Patent Application Laid-Open No. 2007-249857 discusses an information processing apparatus capable of warning about deterioration in image quality before printing is performed that can occur depending on the rendering function that is used in an environment in which the format for generating the print data has a mixture of different rendering functions. According to this information processing apparatus, based on the rendering function, equivalent print setting information is set regardless of the rendering function by converting between an XPS print ticket and development mode (DEVMODE). DEVMODE is a data structure for storing setting information about a printer driver in Windows®.

Further, for example, Japanese Patent Application Laid-Open No. 2008-33812 discusses a user interface in a system for printing XPS documents that receives a page level or print setting information about a document level. In addition, for example, Japanese Patent Application Laid-Open No. 2009-271930 discusses a method that includes a unit (e.g., a user interface (UI)) for editing a common printer definition (e.g., a general purpose datatype (GPD)) that is familiar to a user. The user uses this unit to edit printer definition information, and to ultimately convert and output the information as a JDF job ticket.

However, since the XPS print ticket used in Japanese Patent Application Laid-Open Nos. 2007-249857 and 2008-33812 includes configuration information about the job in the XPS content data, when the job configuration information is to be changed, the contents of the XPS document itself have to be changed.

For example, consider a case in which the user wishes to apply the configuration information “PT_T (print ticket) in the job level, and PT_1 and PT_2 in the first and second pages of the page level”, to other content data as well. In this case, an operation needs to be performed to extract this configuration information from the content data in which the configuration information is included, and embed this configuration information in the content data of the application destination.

Further, the JDF job ticket used in Japanese Patent Application Laid-Open No. 2009-271930 needs to have a very large specification and a complex format in order to realize a commercial printing workflow. Therefore, a great deal of knowledge is required to handle a JDF print ticket.

Thus, there is a need for a technique to control printing performed by an image forming apparatus more easily.

### SUMMARY OF THE INVENTION

The present invention is directed to controlling printing performed by an image forming apparatus more easily.

According to an aspect of the present invention, an information processing apparatus includes a reading unit configured to read setting information indicating a print setting corresponding to a user operation and content information of a print target from a storage device, and a generation unit configured to generate job information to be used in printing by an image forming apparatus by combining the setting information and information indicating that the content information is referred to.

Further, according to another aspect of the present invention, an information processing apparatus includes a generation unit configured to generate print control data that includes configuration information about a hierarchical job and a print ticket separated from the configuration information about the hierarchical job, and a data transmission unit configured to transmit the print control data generated by the generation unit and content data of a print target.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a printing system configuration.

FIGS. 2A and 2B illustrate examples of a hardware configuration of an information processing apparatus.

FIG. 3 illustrates an example of a data flow.

FIG. 4 illustrates an example of a printing control processing flowchart.

FIGS. 5A and 5B illustrate examples of a relationship between a job ticket and a print ticket.

FIGS. 6A and 6B illustrate examples of a job ticket data structure.

FIG. 7 illustrates an example of a printing result.

FIGS. 8A and 8B illustrate examples of a data structure of job related data.

FIG. 9 illustrates an example of a job ticket description.

FIG. 10 illustrates an example of a print ticket description.

### DESCRIPTION OF THE EMBODIMENTS

Various exemplary embodiments, features, and aspects of the invention will be described in detail below with reference to the drawings.

The following exemplary embodiment does not limit the present invention. Moreover, not all of the constituent elements described in the exemplary embodiment are absolutely essential to achieve the object of the present invention.

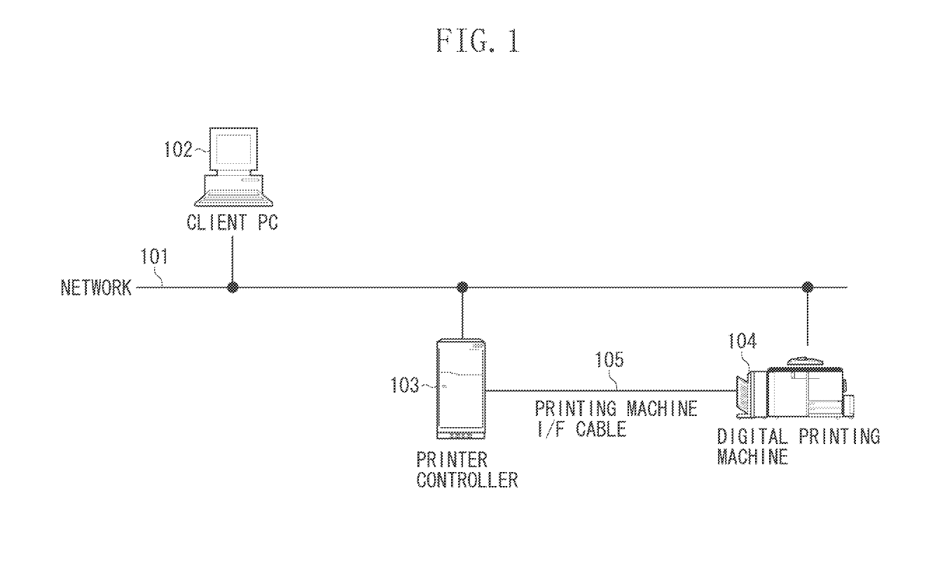

FIG. 1 illustrates an example of a printing system configuration according to the present exemplary embodiment.

This printing system includes a client personal computer (PC) 102, a printer controller 103, and a digital printing machine 104. The client PC 102, the printer controller 103, and the digital printing machine 104 are connected via a network 101 so that they can communicate with each other. Further, the printer controller 103 and the digital printing machine 104 are connected via a printing machine interface (I/F) cable 105 so that they can communicate with each other.

The client PC 102 is an example of an information processing apparatus (computer). The client PC 102 responds to a print order operation received from a user via a print order screen, and generates commercial information corresponding to the order from the user and job information (a job ticket) corresponding to that commercial information. Further, once all the data necessary for printing has been acquired, the client PC 102 transmits the job ticket to the printer controller 103.

The printer controller 103 is an example of an information processing apparatus (computer). The printer controller 103 receives job related data that includes the job ticket transmitted from the client PC 102, interprets the job ticket, and instructs the digital printing machine 104, which has a printing function, to print.

The printer controller 103 also performs raster image processor (RIP) processing on the content data (an example of content information) which is the print target. Further, the printer controller 103 transmits the RIP-processed data (a bitmap etc.) to the digital printing machine 104 via the printing machine interface cable 105. The system may also be configured such that the digital printing machine 104 performs the RIP processing, instead of the printer controller 103.

The digital printing machine 104, which is an example of an image forming apparatus that has a printer function, prints (records on a recording medium) the content data.

In the present exemplary embodiment, as an example, the client PC 102 and the printer controller 103 are connected via a network. However, the present exemplary embodiment is not limited to this configuration. For example, the client PC 102 and the printer controller 103 may be constituted by the same computer.

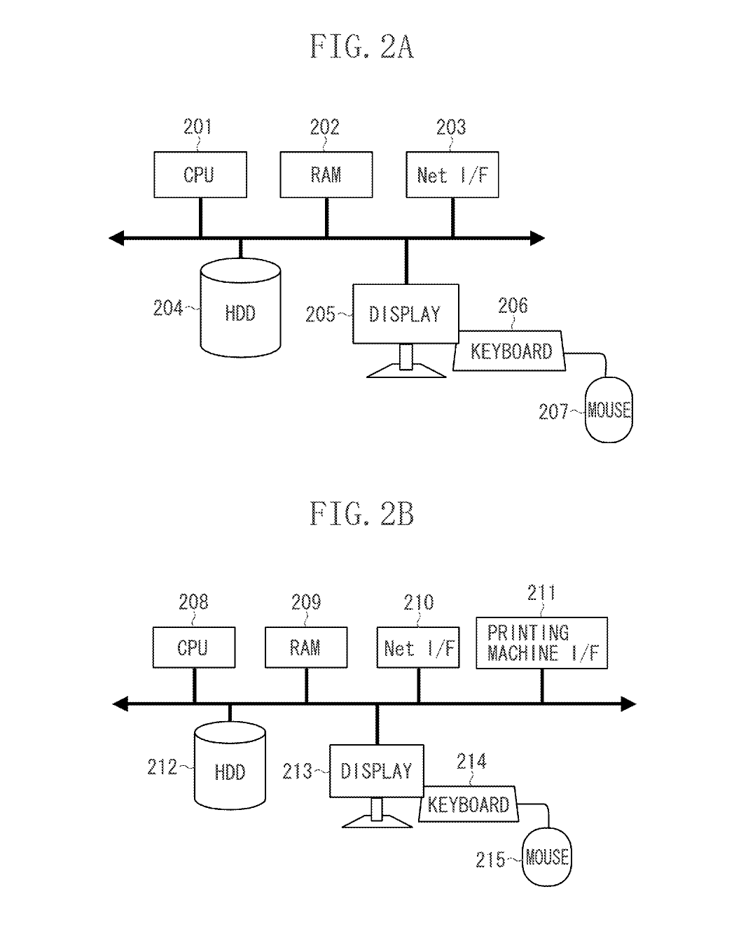

Next, the client PC 102 will be described with reference to FIG. 2A. FIG. 2A illustrates an example of a hardware configuration of the client PC 102. The client PC 102 may employ various commonly known connection methods, various buses, and various interfaces for the respective hardware parts. The hardware configuration described in the present exemplary embodiment is merely one example.

A central processing unit (CPU) 201 controls the whole client PC 102 based on a control program loaded into a random access memory (RAM) 202. The RAM 202 is an internal storage unit into which a control program for the client PC 102 that is executed by the CPU 201, and document and image data, for example, are loaded.

A network I/F (Net I/F) 203 transmits and receives data, for example, by connecting to a network such as the Internet based on control from the CPU 201. A hard disk drive (HDD) 204 stores (saves) various data, such as a control program for the client PC 102. A display 205 displays various types of information. A keyboard 206 and a mouse 207 are examples of a pointing device for inputting various types of information into the client PC 102.

The various programs stored in the HDD 204 are loaded as necessary into the RAM 202, and are executed based on control from the CPU 201 so that the functions of an operating system loaded into the RAM 202 are used as required. More specifically, the CPU 201 executes the functions of the client PC 102 and the processing illustrated in the below-described flowchart, by performing processing based on the procedure of the programs stored in the HDD 204.

Next, the printer controller 103 will be described with reference to FIG. 2B. FIG. 2B illustrates an example of a hardware configuration of the printer controller 103. Similar to the client PC 102, the printer controller 103 may employ various commonly known connection methods, various buses, and various interfaces for the respective hardware parts. The hardware configuration described in the present exemplary embodiment is merely one example.

A CPU 208 controls the whole printer controller 103 based on a control program loaded into a RAM 209. The RAM 209 is an internal storage unit into which a control program for the printer controller 103 that is executed by the CPU 208, and document and image data, for example, are loaded.

A Net I/F 210 transmits and receives data, for example, by connecting to a network such as the Internet based on control from the CPU 208. An HDD 212 stores various data, such as a control program for the printer controller 103. A display 213 displays various types of information. A keyboard 214 and a mouse 215 are examples of a pointing device for inputting various types of information into the printer controller 103. A printing machine interface 211 is connected to the digital printing machine 104 via the printing machine interface cable 105 for transmitting RIP-processed data, for example.

The various programs stored in the HDD 212 are loaded as necessary into the RAM 209, and are executed based on control from the CPU 208 so that the functions of an operating system loaded into the RAM 209 are used as required. More specifically, the CPU 208 executes the functions of the printer controller 103 and the processing illustrated in the below-described flowchart, by performing processing based on the procedure of the programs stored in the HDD 212.

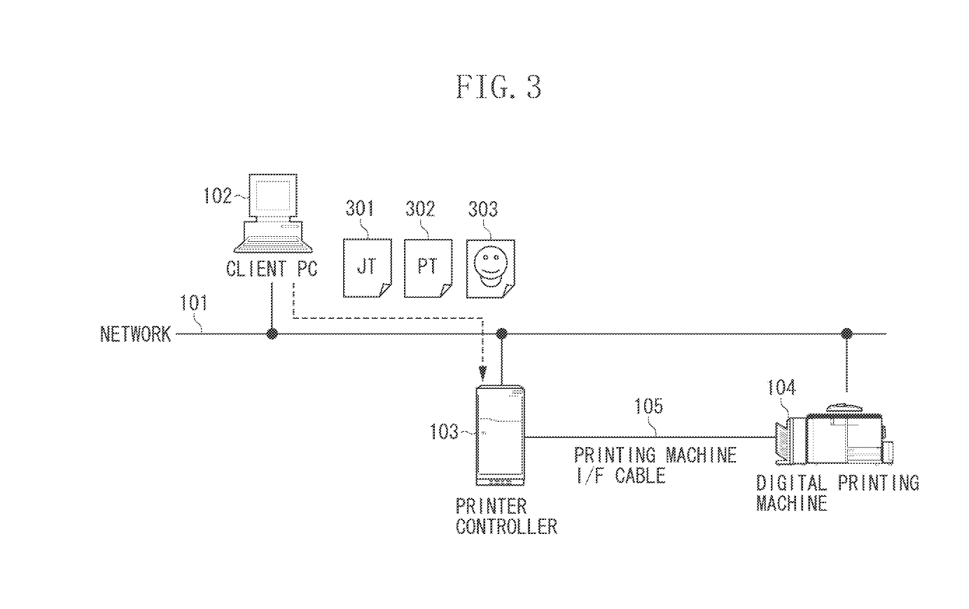

FIG. 3 illustrates an example of a data flow in the present printing system. In this example, a job ticket (JT) 301, a print ticket (PT) 302, and content data 303 are transmitted from the client PC 102 to the printer controller 103. While a configuration in which the print ticket 302 and the job ticket 301 are separate, is described below, a configuration in which the print ticket 302 is embedded in the job ticket 301 may also be employed.

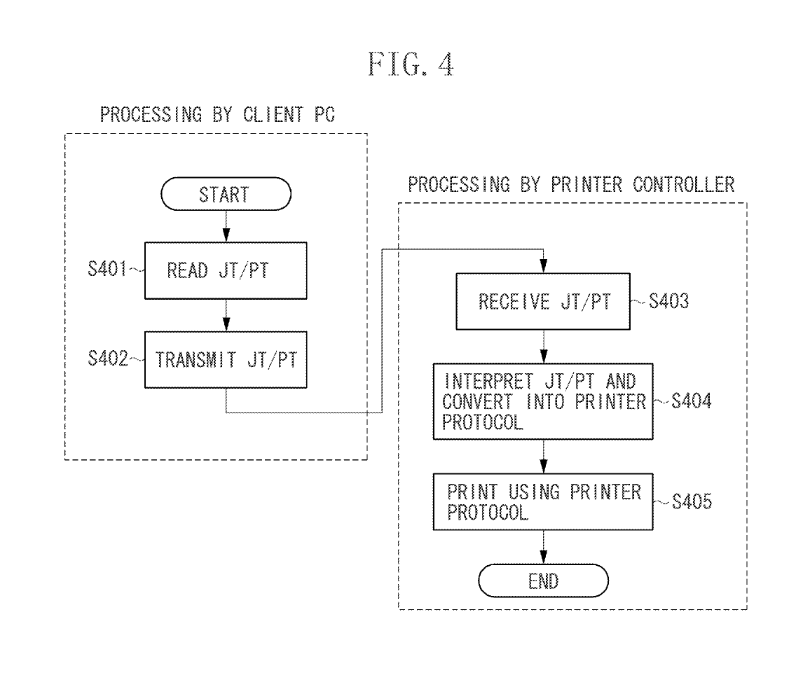

FIG. 4 illustrates an example of a flowchart for the printing control processing in the printing system.

The client PC 102 receives content data 303 and order information input in an operation made by the user (a user operation) on the keyboard, the mouse 207 or the like. Next, in step S401, the client PC 102 reads setting information in response to the user operation, specifically, print control data that includes the job ticket 301 and the print ticket 302 that are provided corresponding to the order information stored in the HDD 204, and loads them into the RAM 202.

The job ticket 301 is a file for holding configuration information about a hierarchical job. Further, the print ticket 302 is a file for holding print setting information about the print settings in the digital printing machine 104. The print setting information includes data relating to the paper size, the paper type, and finishing. The job ticket 301 and the print ticket 302 will be described in more detail below. The content data 303 is an image file, a page description language (PDL) file and the like.

Next, in step S402, the client PC 102 generates job related data based on the print setting data that includes the read job ticket 301 and the print ticket 302, together with the content data 303, and transmits the generated job related data to the printer controller 103. The job related data will be described in more detail below.

In step S403, the printer controller 103 receives the job related data that includes the job ticket 301, the print ticket 302, and the content data 303 that was transmitted from the client PC 102.

Next, in step S404, the printer controller 103 interprets the job ticket 301 and the print ticket 302, and converts the data into a printer protocol for the digital printing machine 104, which is an example of output target printer control information. Then, in step S405, the printer controller 103 controls the digital printing machine 104 to print the content data 303 using the printer protocol.

The job ticket and the print ticket used by the present printing system will now be described.

The job ticket according to the present exemplary embodiment is described in a format based on extensible markup language (XML) that includes accompanying information, such as configuration information about the job. The job ticket according to the present exemplary embodiment will, unless otherwise noted, be referred to simply as “job ticket”.

The print ticket according to the present exemplary embodiment is described in a format based on XML that includes print setting information. The print ticket according to the present exemplary embodiment will, unless otherwise noted, be referred to simply as “print ticket”.

Further, as the job ticket in the present exemplary embodiment, either a job ticket in a format that refers to an external print ticket (external reference format) or a job ticket in a format that describes the contents of the print ticket in the job ticket (inline format) may be employed.

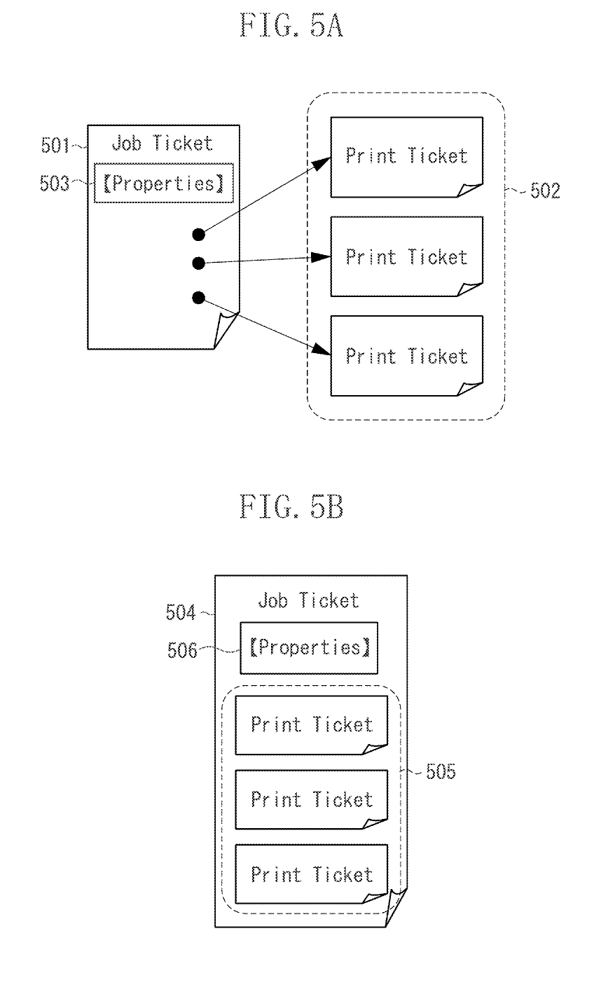

FIG. 5 illustrates examples of the relationship between a job ticket and a print ticket. FIG. 5A illustrates a relationship between a job ticket 501 and a print ticket 502 when an external reference format job ticket is employed. A property 503 represents accompanying information (a property) about the job. The accompanying information may include a job name and a printing priority.

When employing an external reference format job ticket, the job ticket and the print ticket corresponding to the order data are separately stored in advance in the HDD 204. The client PC 102, for example in the above step S402, first, refers to the print ticket corresponding to the order data, and changes the job ticket read from the HDD 204 to the job ticket that refers to the content data (generates job information). Then, the client PC 102 generates job related data that includes the changed job ticket, the print ticket, and the content data, and transmits the generated job related data to the printer controller 103.

FIG. 5B illustrates a relationship between a job ticket 504 and a print ticket 505 when an inline format job ticket is employed. In this case, the contents described in the print ticket 505 are described into the job ticket 504 as it is. A property 506 represents accompanying information about the job.

When employing an inline format job ticket, the job ticket in which the print ticket corresponding to the order data is embedded, is stored in advance in the HDD 204. The client PC 102, for example in the above step S402, first, changes the job ticket read from the HDD 204 to the job ticket that refers to the content data. Then, the client PC 102 generates job related data that includes the changed job ticket and the content data, and transmits the generated job related data to the printer controller 103.

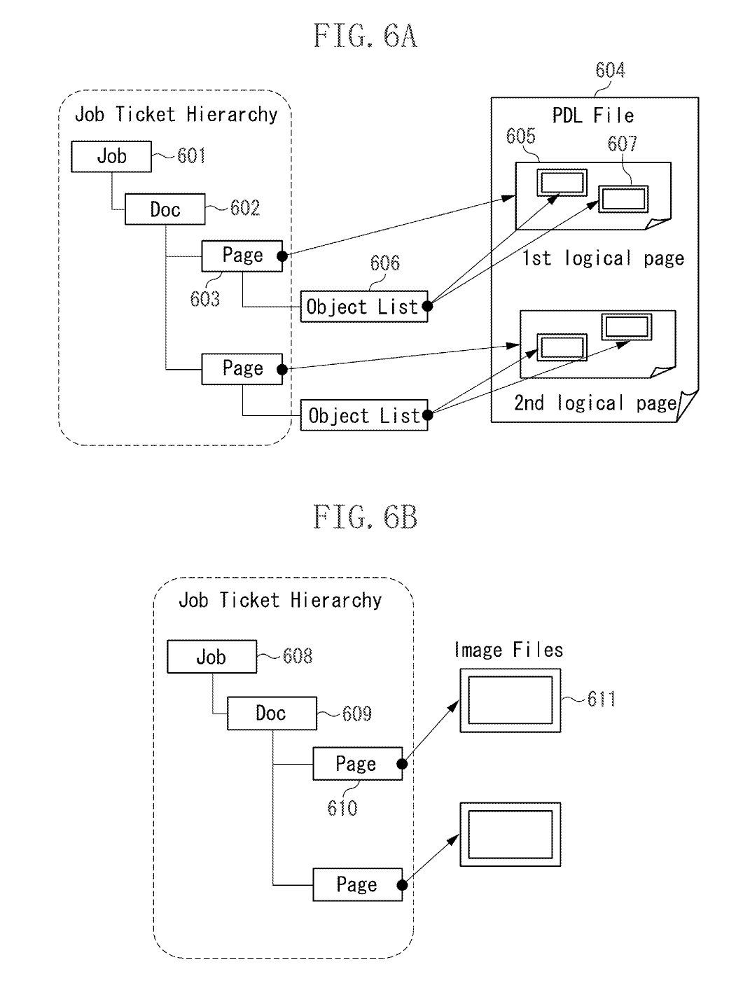

FIG. 6 illustrates examples of the data structure of a job ticket. FIG. 6A illustrates an example of the structure of a job ticket when printing a PDL file (e.g., a portable document format (PDF)). FIG. 6B illustrates an example of the structure of a job ticket when printing an image. The data structure of a job ticket, especially the hierarchical structure, will now be described.

The job ticket has a hierarchical structure consisting of a job level, a doc level, and a page level. The job level is a layer formed from one node (1 layer 1 node), which represents the whole of a job. A job is formed from one or more documents. Further, a job level 601 and a job level 801 represent job levels, and are described as job elements in the job ticket.

The doc level is a layer formed from one or a plurality of nodes (1 layer plural nodes), which represents a document. A document is a page set that includes one or more pages. Further, a doc level 602 and a doc level 802 represent doc layers, and are described as doc elements in the job ticket.

The page level is a layer formed from one or a plurality of nodes (1 layer plural nodes), which represents a page. The page level is the bottom layer in the job ticket hierarchical structure. Further, a page level 603 and a page level 610 represent page levels, and are described as page elements in the job ticket.

When printing a PDL file, each logical page in the PDL file corresponds to a respective page element (layer). More specifically, as illustrated in FIG. 6A, the logical page 605 in the PDL file 604 corresponds to the page level 603.

Further, when printing an image, one image corresponds to one page element (layer). More specifically, as illustrated in FIG. 6B, the image 611 corresponds to the page level 610. For a multipage image (e.g., a multipage tagged image file format (TIFF)), the respective pages in the multipage image correspond to the respective page elements.

When using a PDL file for the content data, the page element can have an object list element, which can hold accompanying information about an image object included in the page element. An object list element 606 indicates that an image object 607 included in the PDL file 604 is referred to. In addition, when using an image for the content data, since the page element corresponds to the image, the page element does not have an object list element.

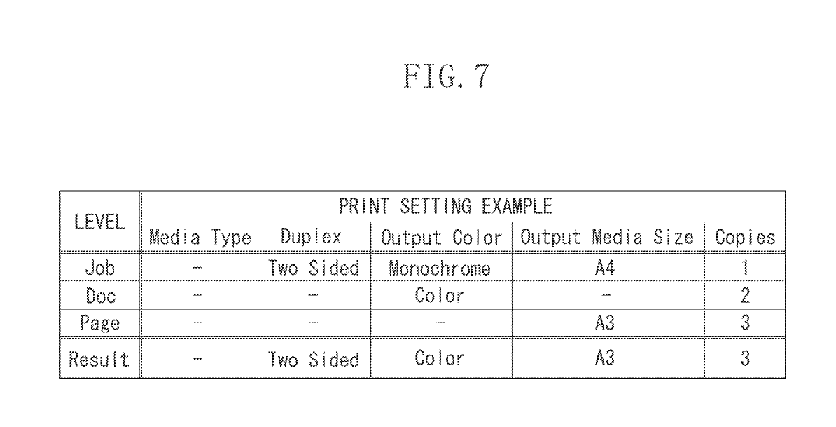

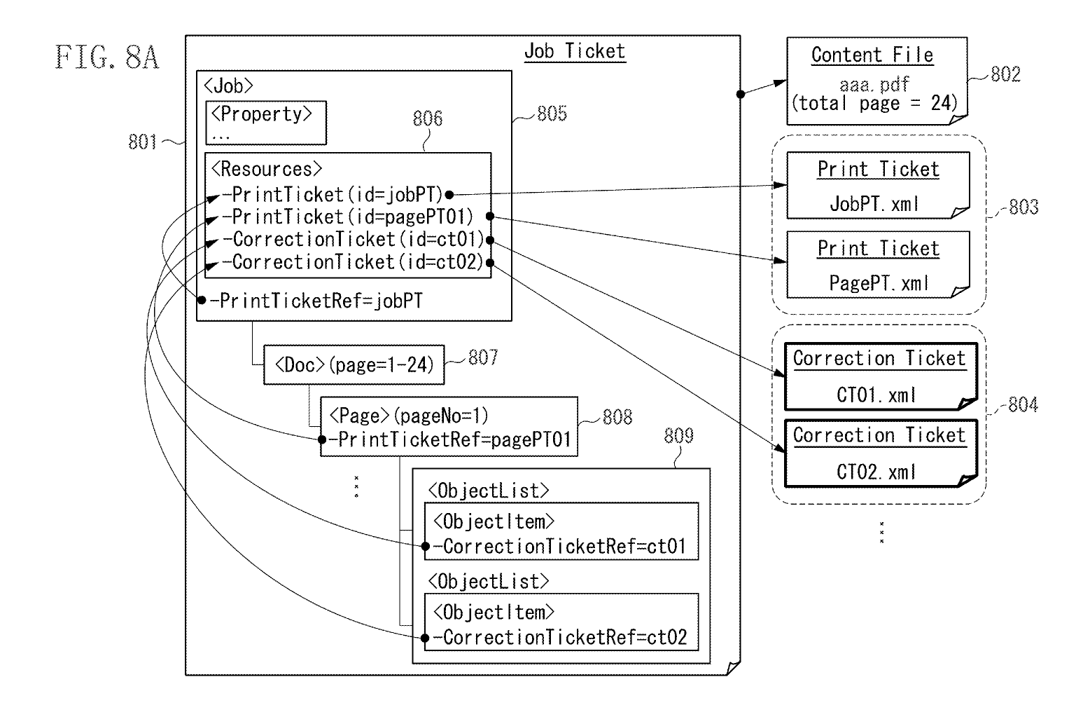

FIG. 7 illustrates an example of a printing result when print setting information is simultaneously provided in a plurality of layers.

The job level, the doc level, and the page level in the job ticket may each include print setting information. When there is overlapping print setting information in a plurality of layers, a setting value in the print setting information for a predetermined layer is used. In the present exemplary embodiment, a setting value in the same print setting information for a higher layer is overwritten with a setting value in the print setting information for a lower layer.

For example, when a job ticket in which “output media size=A4” is set in the job level and “output media size=A3” is set in a page level (e.g., the fifth page), is input into the printer controller 103, the print setting information for the page level, which is a lower layer than the job level, has priority. Therefore, printing is performed using A3 size for the fifth page. Concerning the other pages, printing is performed using A4 size based on the “output media size=A4” in the job level.

According to this configuration, the print setting information can be flexibly set for the whole job (job level), a specific document (doc level), and a specific page (page level). For example, printing can be performed based on a simple description such as “print the second page in monochrome, and the other pages in color”.

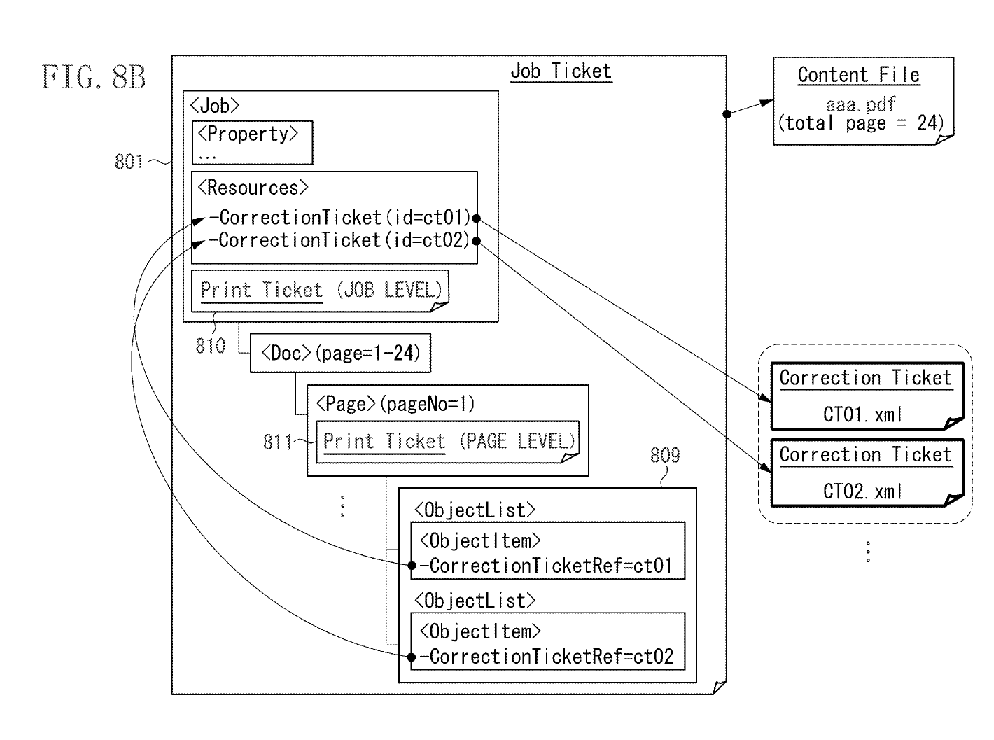

Next, the configuration of job related data will be described with reference to FIGS. 8 to 10. FIG. 8 illustrates an example of the data structure of job related data.

FIG. 8A illustrates an example of job related data when employing an external reference format job ticket.

The job related data includes, for example, a job ticket 801, content data 802, a print ticket 803, and an image correction ticket 804 that will be applied on the content data 802 by the digital printing machine 104. Although the image correction ticket 804 is necessary when performing image correction with the digital printing machine 104, if image correction is not performed, the image correction ticket 804 is not necessary.

The information representing the print ticket 803 that is referred to from the job ticket 801 and the image correction ticket 804 is listed (defined) by a resource element 806 in a job element 805. A reference destination that has a reference ID is described using that reference ID attached to the print ticket 803 and the image correction ticket 804 in the layer (element) that is actually referred to.

In this example, a print ticket having the reference ID “job PT” is referred to in the job level (job element 805), and a print ticket having the reference ID “page PT01” is referred to in the page level (page element 808 (page 1)). Further, it is described in the doc element 807 that the page element 808 belongs to it.

The object list element 809 describes that image correction tickets having the reference ID “ct01” and “ct02” are applied on the respective image objects included in the first page of the content data 802.

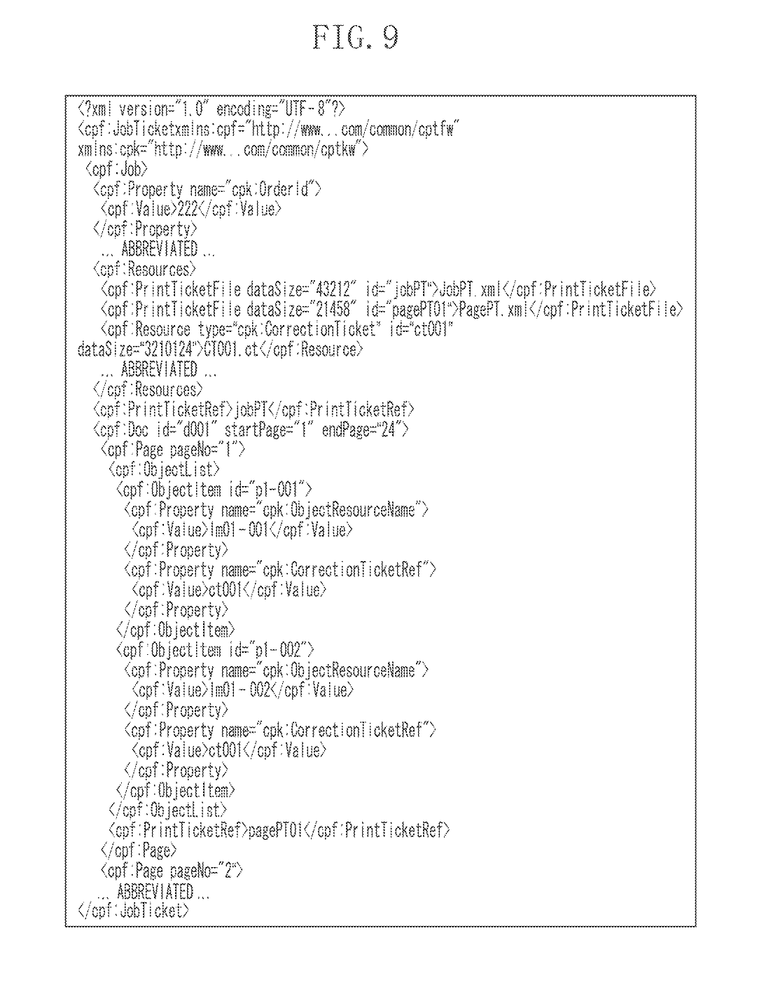

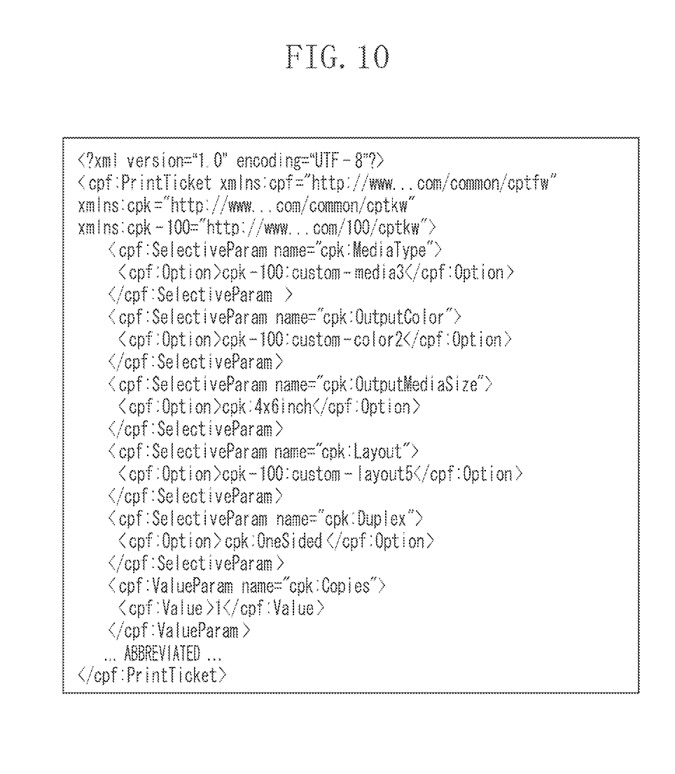

FIG. 9 illustrates an example of a description that actually expresses the job ticket 801 illustrated in FIG. 8A in XML. In FIG. 9, each of the elements described in FIG. 8A are illustrated as an XML element.

FIG. 10 illustrates an example of a description when the print ticket referred to from the job ticket 801 is actually expressed in XML. The print ticket illustrated in FIG. 10 has a print ticket element as a route element. Further, this print ticket has a selective param element and a value param element for describing the print setting items as sub-elements of a route element.

A fixed value is stored in the selective param element, and an arbitrary value is stored in the value param element. The type of print setting item is described in a name attribute of the selective param element and a name attribute of the value param element. The setting values for the respective print setting items are described as character string contents.

As illustrated in FIG. 10, print setting items and setting values having a shared printer type include information relating to an XML namespace “http:// . . . ” indicating that they have shared printer type. Further, print setting items and setting values having a unique printer type include information relating to an XML namespace indicating that they have a unique printer type.

FIG. 8B illustrates an example of job related data when an inline format job ticket is employed. What is different from FIG. 8A is that the print ticket is described in the job ticket. In this example, the print ticket 803 is embedded as a print ticket 810 in the job element and as a print ticket 811 in the page element.

Since external reference format job tickets and inline format job tickets both have their respective merits and demerits, the user can select a format to be used based on the usage case.

First, the merits of an inline format job ticket will be described. For an inline format job ticket, since only one file needs to be handled, data handling in the workflow system is simpler compared with an external reference format job ticket.

Next, the merits of an external reference format job ticket will be described. An external reference format job ticket has greater flexibility than an inline format job ticket when combining the print setting information. For example, it is assumed that there is the following print setting information.

A whole photobook print ticket

Photobook main text print tickets A, B, and C

Photobook cover print tickets E, F, G, and H

In this case, also assume that printing is performed by combining the whole photobook print ticket, the three kinds of photobook main text print ticket (A, B, and C), and the four kinds of photobook cover print ticket (E, F, G, and H).

For example, at a kiosk terminal for ordering a photobook, which is an example of the client PC 102, the main text for a photobook can be selected from among three options, and the cover for that photobook can be selected from among four options. This case has the following two advantages.

First, the storage capacity can be reduced.

In the above example, there are 3×4=12 possible scenarios. When employing an inline format job ticket, 12 job tickets are stored and one of the job tickets is used for printing based on the option selected by the user.

In contrast, when employing an external reference format job ticket, all combinations can be expressed by storing 9 files (1 job ticket and 8 print tickets). Consequently, a job ticket and a print ticket that are combined based on the option selected by the user can be used for printing.

In addition, while an inline format job ticket includes descriptions in each of the 12 job tickets, only one job ticket has to be prepared for an external reference format job ticket. Accordingly, the storage capacity can be reduced even further.

The second advantage is a reduction in the number of steps required to correct the print ticket.

For example, when there is a partial correction to the print ticket for the whole photobook, in a case of an inline format job ticket, all of the 12 job tickets have to be rewritten. In contrast, in a case of an external reference format job ticket, print tickets other than the print ticket for the whole photobook do not need to be dealt with.

According to the above configuration, since configuration information and print setting information about a job can be held separate from the content data, pre-prepared job configuration information and print setting information can be applied to other contents without having to edit the content data. Further, the data summarizing the print setting information and the document layer having the content data can be flexibly associated, which makes it easier to reuse and maintain the print setting information.

According to the above exemplary embodiment, printing performed by an image forming apparatus can be controlled more easily.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a

memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-279396 filed Dec. 15, 2010, which is hereby incorporated by reference herein in its entirety.

What is claimed is:

1. An information processing apparatus comprising:
a reading unit configured to read setting information indicating a print setting corresponding to a user operation and content information of a print target, from a storage device; and
a generation unit configured to generate job information to be used in printing in an image forming apparatus based on the setting information and information indicating that the content information is referred to.

2. The information processing apparatus according to claim 1, wherein in the setting information, print setting information indicating a setting item for printing by the image forming apparatus and a value of the item are embedded in configuration information indicating a job configuration.

3. The information processing apparatus according to claim 1,
wherein the storage device stores, as the setting information, configuration information indicating a job configuration and print setting information indicating a setting item for printing in the image forming apparatus and the value of the item,
wherein the reading unit is configured to read the configuration information corresponding to the user operation, the print setting information, and the content information, and
wherein the generation unit is configured to generate the job information which includes in the configuration information indicating that the content information is referred to and information indicating that the print setting information is referred to.

4. The information processing apparatus according to claim 1, further comprising:
a control information generation unit configured to generate control information for controlling printing in an image forming apparatus by reading from a storage device job information which combines information indicating that the content information of the print target is referred to, with setting information indicating a print setting; and
a control unit configured to read the content information from the storage device based on the information indicating that the content information is referred to, and to control printing of the content information in the image forming apparatus based on the control information.

5. The information processing apparatus according to claim 4,
wherein the job information is configured from a plurality of layers in which print setting information indicating a setting item for printing in the image forming apparatus and the value of the item can be provided, and
wherein the generation unit is configured to generate control information using print setting information in a predetermined layer when, in the print setting information provided in a plurality of layers, there is print setting information in which an item is the same but the value is different.

6. An information processing apparatus comprising:
a generation unit configured to generate print control data that includes configuration information about a hierarchical job and a print ticket separated from the configuration information about the hierarchical job; and
a data transmission unit configured to transmit the print control data generated by the generation unit and content data of a print target.

7. A method for controlling printing by an information processing apparatus, the method comprising:
reading setting information indicating a print setting corresponding to a user operation and content information of a print target, from a storage device; and
generating job information to be used in printing in an image forming apparatus based on the setting information and information indicating that the content information is referred to.

8. The printing control method according to claim 7, further comprising:
generating control information for controlling printing in an image forming apparatus by reading from a storage device job information which combines information indicating that the content information of the print target is referred to, with setting information indicating a print setting; and
reading the content information from the storage device based on the information indicating that the content information is referred to, and controlling printing of the content information in the image forming apparatus based on the control information.

9. A printing control method comprising:
generating print control data that includes configuration information about a hierarchical job and a print ticket separated from the configuration information about the hierarchical job; and
transmitting the generated print control data and content data of a print target.

10. A non-transitory computer-readable storage medium storing computer-executable instructions which when executed by a computer cause the computer to perform a method for controlling printing by an information processing apparatus, the method comprising:
reading setting information indicating a print setting corresponding to a user operation and content information of a print target from a storage device; and
generating job information to be used in printing in an image forming apparatus based on the setting information and information indicating that the content information is referred to.

11. The computer-readable storage medium according to claim 10, the method further comprising:
generating control information for controlling printing in an image forming apparatus by reading from a storage device job information which combines information indicating that the content information of the print target is referred to, with setting information indicating a print setting; and
reading the content information from the storage device based on the information indicating that the content information is referred to and controlling printing of the content information in the image forming apparatus based on the control information.

12. A non-transitory computer-readable storage medium storing computer-executable instructions which when executed by a computer cause the computer to perform a method for controlling printing by an information processing apparatus, the method comprising:
generating print control data that includes configuration information about a hierarchical job and a print ticket separated from the configuration information about the hierarchical job; and
transmitting the generated print control data and content data of a print target.
